(19) United States
(12) Patent Application Publication
(10) Pub. No.: US 2019/0350814 A1
(43) Pub. Date: Nov. 21, 2019

(54) Baby Bottle Holding Device

(71) Applicant: Christian Patrick Powers, Bowling Green, OH (US)

(72) Inventor: Christian Patrick Powers, Bowling Green, OH (US)

(21) Appl. No.: 16/413,243

(22) Filed: May 15, 2019

Related U.S. Application Data
(60) Provisional application No. 62/671,428, filed on May 15, 2018.

(51) Int. Cl. A61J 9/06

(52) U.S. Cl. CPC A61J 9/0638; A61J 9/0676

(57) ABSTRACT

The present preferred embodiment of the invention is comprised of (but not limited to this combination of materials, fasteners, or manner of fastening) three main parts of novel utility and flexible design consisting of two flexible loops of material that mechanically secure to your arm, the bottle (or the like), and each other to facilitate the positioning of the bottle (or the like) so that it is accessible to an infant to feed form while being held in your arm.

### BACKGROUND OF THE INVENTION

I created the current embodiment of the device to fulfill a need I had when my son was born. Many parents must either entirely bottle feed, or supplement the natural breast feeding of a child with bottle feeding. I was no different. I found that when bottle feeding I was locked into that activity with both hands and arms occupied with that task for an undeterminable amount of time. I looked for a solution on the market to provide me with some freedom, flexibility and mobility and all other devices fell short and did not provide the functionality that I needed, so I created one that does. The device allows me to have one hand and arm free while bottle feeding, It also allows me to stand and be mobile while feeding is not interrupted. This lead to greater flexibility and freedom in my daily life. No other device on the market provided me with this amount of functionality, flexibility and freedom as efficiently and effectively.

### FIELD OF THE INVENTION

The present invention relates to the field of baby bottle holding devices. In particular, bottle holding devices that are designed to provide some level of hand free feeding of an infant or other.

### DESCRIPTION OF RELATED ART

The current state of the art is comprised of holders that hang form the neck or shoulder of the person feeding the baby, the baby itself, or inanity objects such as strollers, cribs, high chairs and the like which do not provide the mobility or functionality that my Baby Bottle Holding Device does. Here are examples of previous art:
1. Baby bottle holder—U.S. Pat. No. 3,718,360A—F Knutzen—Filing 1971 Mar. 15
2. Baby bottle Holder—U.S. Pat. No. 5,873,551A—Philip J. Jones Jones; Philip J.
3. Holder for nursing-bottles—U.S. Pat. No. 871,622A—Jane E Pettee—Filing 1907 Jul. 24
4. Baby bottle keeper—U.S. Pat. No. 5,613,657A—James Olaiz Junior Products Inc.—Filing 1995 Jun. 7
5. Baby bottle support—U.S. Pat. No. 5,582,335A—Mark D. Beard Beard; Mark D.—Filing
6. 1994 Jun. 6
7. Nursing bottle holder—U.S. Pat. No. 4,220,302A—Jarold L. HamptonHampton Diane M—Filing 1978 Jul. 21
8. Nursing bottle holder—U.S. Pat. No. 2,494,632A—Rodin Robert—Victor Rodin W—Filing 1948 Oct. 22
9. Universal baby bottle holder—U.S. Pat. No. 3,216,687A—Ann H Vardan—Filing—1964 Feb. 25
10. Nursing bottle holder—U.S. Pat. No. 3,065,944A—Georgia R Liebendorfer—Filing—1958 Jan. 7
11. Nursing bottle holder—U.S. Pat. No. 2,764,376A—Charles E Dyer—Filing—1953 Sep. 1
12. Baby bottle holder—U.S. Pat. No. 5,711,500A—Victor De Los Santos—Filing 1995 Aug. 16
13. Mouth-holdable bottle holder—U.S. Pat. No. 9,220,662B2—Asaf Amitai—Filing—2012 Jan. 29
14. Apparatus and method for preparing ingredients for a baby bottle—U.S. Pat. No. 9,022,081B2—Cara A.—Armstrong Baby Barista, Inc.—Filing 2012 Aug. 2
15. Crib baby bottle holder for self-feeding—U.S. Pat. No. 9,433,561B2—Allen Rubinstein—Filing 2015 Jan. 5
16. Mouth-holdable bottle holder—U.S. Pat. No. 9,220,662B2—Asaf Amitai—Filing 2012 Jan. 29
17. Milk bottle holder for baby carriage—CN204050359U— [symbol]
18. [symbol] —Filing 2014 Oct. 17
19. Crib baby bottle holder for self-feeding—U.S. Pat. No. 8,925,876B2—Allen Rubinstein—Filing 2012 Oct. 19
20. Reversible head-support and bottle-support baby pillow—U.S. Pat. No. 8,281,435B2—Charles Samuel Kent—Filing 2010 Jul. 8
21. Automatic heating type bamboo baby feeding bottle rack—CN203724480U— [symbol] [symbol] —Filing 2014 Jan. 16
22. Baby nursing bottle holder—CN202151437U— [symbol] —Filing 2011 Jul. 15
23. Baby bottle support system for feeding a baby—U.S. Pat. No. 8,915,408B1—Martin Richard Hill—Filing 2013 Jan. 14

### BRIEF SUMMARY OF THE INVENTION

In one embodiment of the present invention, a baby bottle is fastened to a person's arm using two flexible material loops that are fastened together using a mechanical fastener in order to free one hand and arm while feeding a baby.

### DRAWINGS

The terminology used herein is for the purpose of the describing particular embodiments only and is not intended to be limiting of the invention. As use herein, the term “and/or” includes any and all combination of one or more of the associated listed items as used herein, the singular form “A,” “an”, and “the” are intended to include the plural forms as well as the singular forms, unless the context clearly indicates otherwise. It will be further understood that the terms “comprises”, and/or “comprising,” when used in the specification, specifically the presence of stated features, steps, operation, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms such as those defined in commonly used dictionaries, should be interpreted as having a meaning that is consistent with their meaning in the context of the relevant art and the present disclosure and will not be interpreted in an idealized of overly formal sense unless expressly so defined herein.

The present disclose is to be considered as an exemplification or the invention, an is not intended to limit the invention to the specific embodiments illustrated by the figures or descriptions below.

These embodiments of the present preferred invention are illustrated as an example and are not limited to the figures in the accompanying drawings.

### BRIEF DESCRIPTION OF SEVERAL VIEWS OF THE DRAWING

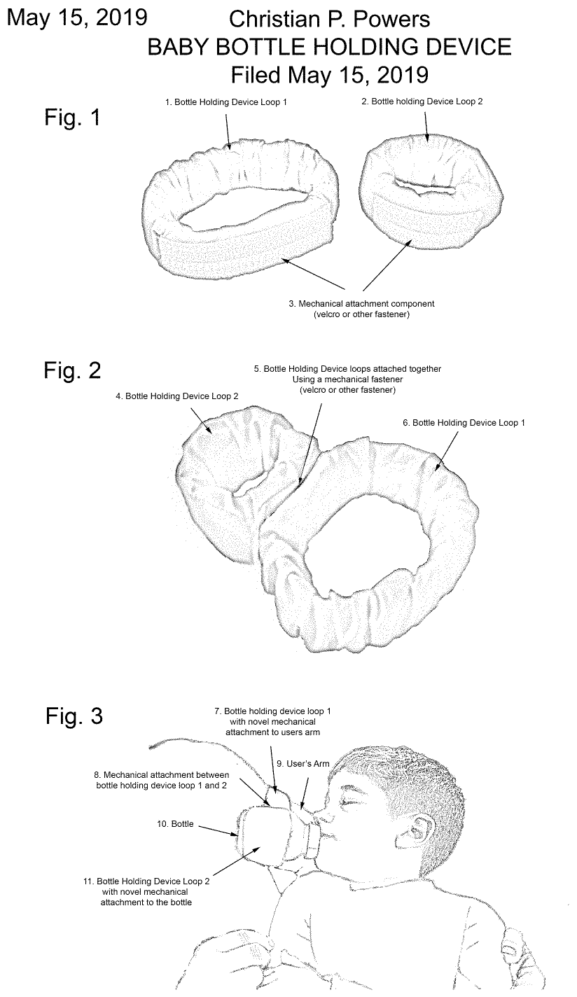

FIG. 1 depicts a perspective view of an embodiment of (but not limited to) the three main pieces of the bottle holding device; bottle holder device loop 1 and bottle holding device loop 2 and their mechanical fasteners. Bottle holding device loop 1 and the bottle holding device loop 2 are in a detached state and side by side from one another. The mechanical fasteners are shown attached to each loop.

FIG. 2 depicts a perspective view of an embodiment of the three main pieces of the bottle holding device; Bottle holding device loop 1 fastened to bottle holding device loop 2 using the mechanical fastener.

FIG. 3 is a perspective view of an embodiment of the bottle holding device being used. You can see that loop 1 is mechanically fastened to the user's arm, loop 1 and loop 2 are mechanically fastened together by the mechanical fasteners, and loop 2 is mechanically fastened to the bottle that the child is feeding form.

### DETAILED DESCRIPTION OF THE DRAWINGS

### Referring to the Drawings by Reference Numbers

1 denotes the bottle holding device loop 1 that mechanically fastens to the user's arm. This embodiment having (but not limited to this combination of materials, fasteners, or manner of fastening that connects a bottle [or the like] to one's arm for the feeding of a child or other living creature) a cloth sheathing over a strap of elastic sewn into a loop and a mechanical Velcro Fastener sewn in to the cloth sheathing that may be mechanically fastened to one's arm by being slid over, wrapped around, or by other means fastened to one's arm.
2 denotes the bottle holding device loop 2 that mechanically fastens to a baby bottle (or the Like); this embodiment having (but not limited to this combination of materials, fasteners, or manner of fastening that connects a bottle [or the like] to one's arm for the feeding of a child or other living creature) a cloth sheathing over a strap of elastic sewn into a loop and a mechanical Velcro Fastener sewn in to the cloth sheathing that may be mechanically fastened to a bottle (or the like) by being slid over, wrapped around, or by other means fastened to a baby bottle (or the like).
3 denotes a mechanical fastener (Velcro or another fastener) attached to bottle holding device loop 1 and a mechanical fastener (Velcro or other fastener) that is attached to bottle holding device loop 2. These Mechanical fasteners fasten to each other and are used to connect the two bottle holding device loops together to be used in conjunction to connect the baby bottle (or the like) to the user's arm to facilitate presenting the bottle for feeding.
4 denotes the bottle holder device loop 2 mechanically fastened to bottle holder device loop 1 by means of mechanical fasteners (Velcro or other fastener) that are attached to both bottle holder device loop 1 and bottle holder device loop 2; this embodiment of bottle holding device loop 2 having (not limited to but including all other possible variations and combinations of materials, fasteners, and manner of fastening that connects a bottle [or the like] to one's arm for the feeding of a child or other living creature) a cloth sheathing over a strap of elastic sewn into a loop and a mechanical Velcro fastener sewn in to the cloth sheathing that may be mechanically fastened to a bottle (or the like) by being slid over, wrapped around, or by other means fastened to a baby bottle (or the like).
5 denotes the mechanical fastener (Velcro or another fastener) that is attached to bottle holding device loop 1 and a mechanical fastener (Velcro or other fastener) that is attached to bottle holding device loop 2 fastened together connecting bottle holding device loop 1 to bottle holding device loop 2.
6 denotes the bottle holder device loop 1 mechanically fastened to bottle holder device loop 2 by means of mechanical fasteners (Velcro or other fastener) that are attached to both bottle holder device loop 1 and bottle holder device loop 2; this embodiment of bottle device loop 1 having (not limited to but including all other possible variations and combinations of materials, fasteners, and manner of fastening that connects a bottle [or the like] to one's arm for the feeding of a child or other living creature) a cloth sheathing over a strap of elastic sewn into a loop and a mechanical Velcro fastener sewn in to the cloth sheathing that may be mechanically fastened to a bottle (or the like) by being slid over, wrapped around, or by other means fastened to a baby bottle (or the like).
7 denotes the bottle holding device loop 1 mechanically fastened to the user's arm and also mechanically fastened to bottle holding device loop 2 by means of a Velcro fastener. This embodiment having (not limited to but including all other possible variations and combinations of materials, fasteners, and manner of fastening that connects a bottle [or the like] to one's arm for the feeding of a child or other living creature) a cloth sheathing over a strap of elastic sewn into a loop and a mechanical Velcro fastener sewn in to the cloth sheathing that may be mechanically fastened to one's arm by being slid over, wrapped around, or by other means fastened to one's arm.
8 denotes the mechanical fastener (Velcro or another fastener) that is attached to bottle holding device loop 1 and a mechanical fastener (Velcro or other fastener) that is attached to bottle holding device loop 2 fastened together connecting bottle holding device loop 1 to bottle holding device loop 2.
9 denotes the user's arm mechanically fastened to bottle holding device loop 1 that mechanically fastens to the user's arm. This embodiment of bottle holding device loop 1 having (not limited to but including all other possible variations and combinations of materials, fasteners, and manner of fastening that connects a bottle [or the like] to one's arm for the feeding of a child or other living creature) a cloth sheathing over a strap of elastic sewn into a loop and a mechanical Velcro Fastener sewn in to the cloth sheathing that is mechanically fastened to the user's arm by being slid over, wrapped around, or by other means fastened to one's arm.
10 denotes a baby bottle (or the like) being held by and fastened to bottle holding device loop 2; this embodiment of bottle holding device 2 having (not limited to but including all other possible variations and combinations of materials, fasteners, and manner of fastening that connects a bottle [or the like] to one's arm for the feeding of a child or other living creature) a cloth sheathing over a strap of elastic sewn into a loop and a mechanical Velcro fastener sewn in to the cloth sheathing that is mechanically fastened to a bottle (or the like) by being slid over, wrapped around, or by other means fastened to a baby bottle (or the like).
11 denotes bottle holding device loop 2 mechanically fastened to a baby bottle (or the like) and also mechanically fastened to bottle holding device loop 1 by means of a Velcro fastener. This embodiment having (but not limited to this combination of materials, fasteners, or manner of fastening) a cloth sheathing over a strap of elastic sewn into a loop and a mechanical Velcro fastener sewn in to the cloth sheathing that is mechanically fastened to the user's arm by being slid over, wrapped around, or by other means fastened to one's arm.

### DETAILED DESCRIPTION OF THE INVENTION

The present preferred embodiment of the invention is comprised of (but not limited to this combination of materials, fasteners, or manner of fastening) three main parts of novel utility and flexible design consisting of two flexible loops of material that mechanically secure to your arm, the bottle (or the like), and each other using elastic or straps that form flexible loops that mechanically attach to each other using Velcro or another mechanical fastener. Once attached to your arm and bottle (or the like) the device facilitates the positioning of the bottle (or the like) so that it is accessible to an infant to feed form while being held in your arm. The device moves with your arm and the baby and will not fall off. The flexibility of the two material loops allow the bottle (or the like) to move reasonably freely so that it adapts to the motion of your arm and the head position of the baby or infant in relation to the bottle. The second loop that is attached to the bottle may be easily removed from the first loop by simply pulling the mechanical Velcro/fastener apart and reattached by simply applying a slight force to reattach the loops.

1. A baby bottle holding device comprising:
1. Two flexible loops that fasten to each other by means of a mechanical fastener
2. When the two loops are fastened together, one loop is connected to the user's arm and the other to a baby bottle or the like in order to hold the bottle in a functional position from which a baby being held in that arm can feed.
